(19) United States
(12) Patent Application Publication
(10) Pub. No.: US 2024/0026110 A1
(43) Pub. Date: Jan. 25, 2024

(54) EXPANDABLE POLYLACTIC ACID-BASED THERMAL AND PROTECTIVE PACKAGING AND METHODS THEREOF

(71) Applicant: Lifoam Industries, LLC, Greer, SC (US)

(72) Inventors: Saumitra Bhargava, Clarksville, MD (US); Jonathan Godfrey, Joppa, MD (US)

(21) Appl. No.: 18/356,611

(22) Filed: Jul. 21, 2023

Related U.S. Application Data
(60) Provisional application No. 63/369,005, filed on Jul. 21, 2022.

(51) Int. Cl. C08J 9/34; C09D 11/033

(52) U.S. Cl. CPC C08J 9/34; C09D 11/033; C08J 2367/04

(57) ABSTRACT

Molded foam articles are provided. The molded foam articles have at least one surface having at least a portion that has been skin-formed for improving the thermal and mechanical properties of the molded foam articles without the need for material, density, or foam particle size changes.

### CROSS-REFERENCE TO RELATED APPLICATIONS

This application claims priority to U.S. Provisional Patent Application No. 63/369,005, filed Jul. 21, 2022, which is incorporated herein by reference.

### FIELD OF THE DISCLOSURE

This disclosure relates generally to molded foam articles and, in particular, relates to molded foam articles formed from polylactic acid having skin-formed surfaces.

### BACKGROUND

Molded foam articles are used in a variety of diverse industries including thermal insulation and protective packaging, construction, infrastructure support, foodservice, and consumer products such as surfboards. Molded foam articles are commonly produced from expandable polystyrene (EPS), which has a well-known manufacturing process. However, EPS-based foam articles suffer from a variety of drawbacks that require compensating the properties of the EPS-based foam articles so that they may successfully be used for their desired purpose.

Consumer-facing foam articles such as insulated shippers are commonly used for shipping meal kits, confectionary products, cakes, other perishable goods, and pharmaceutical items such as vaccines. Other thermal shippers lack appreciable resistance to water transfer, requiring a hydrophobic barrier which requires more resources than recovered by recycling.

Furthermore, shipping appliances and other heavy goods requires protective foam having higher compressive and flexural properties. EPS-based packaging must be at least 0.5 inches thick and must be produced at super high density to achieve the higher compressive and flexural properties. This results in higher energy and material use for production. In other words, EPS-based packaging uses higher density foam to achieve higher compressive strength, but at the cost of increased material content. It is desirable to keep material content low while increasing compressive strength, which is not possible with EPS-based packaging.

The impact and vibration protection provided by protective packaging varies by direction. Conventional EPS-based packaging has mechanical properties in the x-y plane as compared to the x-z or y-z plane that is within 20% for larger and heavier parts and within 10% for smaller and lighter parts. This variation is a side effect of the EPS production method. However, it is desirable to have a low weight foam product engineered with mechanical properties in different directions that vary by amounts greater than 20% to provide sufficient protection to heavy parts without increasing the weight of the protective packaging.

Accordingly, improved molded foam articles are needed for overcoming one or more of the technical challenges described above.

### BRIEF DESCRIPTION OF THE DRAWINGS

The detailed description is set forth with reference to the accompanying drawings. The use of the same reference numerals may indicate similar to identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

The patent or application file contains at least one drawing executed in color. Copies of this patent or patent application publication with color drawing(s) will be provided by the Office upon request and payment of the necessary fee.

FIG. 1 is a perspective view of a molded bead foam article with a skin-formed surface in accordance with the present disclosure.

FIG. 2A is a side view of a molded bead foam article with a skin-formed surface in accordance with the present disclosure.

FIG. 2B is a side view of a molded bead foam article with a skin-formed surface in accordance with the present disclosure.

FIG. 3A is a top view of a molded bead foam article with identifying information printed thereon in accordance with the present disclosure.

FIG. 3B is a top view of a molded bead foam article with a skin-formed surface with identifying information printed thereon in accordance with the present disclosure.

### DETAILED DESCRIPTION

Molded foam articles are provided herein including molded foam articles having one or more skin-formed surfaces. In particular, it has been unexpectedly discovered that forming a skin on one or more surfaces on the molded bead foam article enhances the molded bead foam article properties to a degree greater than or, in some cases, impossible in a comparable EPS molded foam article.

Throughout this disclosure, various aspects are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

As used herein, the term “about” with reference to dimensions refers to the dimension plus or minus 10%.

Molded Bead Foam Articles

Molded foam articles are disclosed herein. In some embodiments, the molded foam articles comprise polylactic acid (PLA). As used here, a “molded foam article” refers to an article formed from a polymeric foam that has gone through an expansion and bead molding process. The article may be in the form of a two-dimensional panel or a three-dimensional structure such as a box. Other polymeric foams are capable of being expanded and molded in a way similar to expandable polystyrene, such as polypropylene, polyethylene, polyurethane and polylactic acid.

In some embodiments, the molded bead foam article includes at least one surface, at least a portion of which has been skin-formed. As used herein, a “skin-formed” surface or portion of a surface is one that has gone through a “skin-forming” process by which the portion of the surface is exposed to sufficient heat, optionally with the application of pressure, so that the molded beads at the surface of the molded bead foam article experience a heightened degree of fusion compared to the beads in the interior of the molded bead foam article. Skin-forming results in a smoother surface compared to a surface that has not been skin-formed, and the skin-formed surface imparts heightened compressive strength, tensile strength, and flexural strength to the molded bead foam article compared to a molded bead foam article without a skin-formed surface. It has further been unexpectedly discovered that skin-forming can be performed on curved or irregular surfaces, enabling these mechanical and thermal enhancements on surfaces that were previously incapable of enhancements, even by conventional means.

In some embodiments, a portion of the surface is skin-formed. For example, the surface may have a size suitable for use as an insulated shipper, and the skin-formed portion of the surface may have a size suitable printing identifying information on the skin-formed portion of the surface. In some embodiments, the entire surface is skin-formed so that the improved mechanical and thermal properties described herein are imparted to the molded bead foam article. In some embodiments, more than one discrete portion of the surface is skin-formed, such as two portions, three portions, or more. In some embodiments, the skin-formed portion or portions has a shape, such as a square, rectangle, circle, or another shape that corresponds to a specific object intended to be shipped within the molded foam article. In some embodiments, the skin-formed portion is intended for printing identifying information. In other embodiments, the skin-formed portion is intended to create a crease or fold in the molded foam article to facilitate bending or folding.

In some embodiments, the skin-formed portion of the at least one surface has a greater compressive resistance than a conventional EPS-based foam article having the same density. In some embodiments, the skin-formed portion of the at least one surface has a lower density than a conventional EPS-based foam article having the same compressive resistance.

Without intending to be bound by any particular theory, conventional EPS molding processes produce an EPS-based molded foam article incapable of skin-formed because of the presence of pentane blowing agent within the EPS beads. Performing a skin-forming process on freshly molded or, in some cases, up to 72-hour aged EPS-based molded foam articles results in either overexpansion of the beads that form the molded article surface, or a contraction of cells that subsequently forms a weak crystalline skin, deteriorating the mechanical properties of the article. If a particular compressive resistance, tensile strength, or flexural strength is desired in an EPS-based molded foam article, the density must be increased. Similarly, if a particular density and/or weight are desired in an EPS-based molded foam article, some degree of compressive resistance or flexural strength must be sacrificed. A high compressive strength and modulus in an EPS-based molded foam article is only achievable at densities of at least 2 pcf, even as high as 4 pcf. In contrast, the skin-formed portion of the at least one surface of the PLA-based molded bead foam article of the present disclosure has the same compressive strength and modulus at a density of only 1.6-1.8 pcf. In some embodiments, the skin-formed portion of the at least one surface has a density of between about 1.0 pcf and about 6.0 pcf.

In some embodiments, the skin-formed portion of the at least one surface has a compressive resistance that is 30%-50% greater than the same PLA-based molded bead foam article without at least one skin-formed portion. It has been unexpectedly discovered that precise selection of the portion of the at least one surface to be skin-formed permits selective reinforcement of the PLA-based molded bead foam article. For example, skin-forming only an edge, a corner, or multiple edges and/or corners improves the compressive resistance of the edges and/or corners such that the molded bead foam article is capable of passing a drop test. Conventional EPS-based foam articles require an increase in density in order to pass a drop test.

In some embodiments, the skin-formed portion of the at least one surface is leak-proof. Molded foam articles are often used as coolers, and shipping certain commodities such as seafood is ideally performed with a shipper that will not secrete any liquids from within the shipper. It has been surprisingly discovered that skin-forming at least a portion of at least one surface of a molded foam article can increase the resistance to water elution through the skin-formed portion. In some embodiments, the inside surface may be skin-formed to avoid secretion of liquid. In some embodiments, the outside surface may be skin-formed to avoid secretion of liquid. In some embodiments, both the inside surface and the outside surface may be skin-formed to avoid secretion of liquid.

In some embodiments, the skin-formed portion of the at least one surface has an R-value that is unchanged in at least 1 year when exposed to water. As used herein, the “R-value” refers to an insulation's resistance to thermal energy transfer and is calculated according to the Formula I. In contrast, the R-value of EPS-based molded foam articles lowers by about 6% after extended exposure to water, and the R-value of extruded polystyrene (XPS) lowers by about 48% after extended exposure to water. The PLA-based molded articles described herein have similar R-values compared to EPS or XPS; however, the R-value changes negligibly after extended exposure to water.

$$R = \frac{Δ T}{{ϕ}_{q}} \qquad Formula I$$

R=R value
ΔT=temperature difference between the warmer surface and colder surface of a barrier
ϕ_{q}=heat flux through the barrier

In some embodiments, the molded bead foam article with at least one skin-formed portion of at least one surface is capable of being used as a shipper with no additional material. In some embodiments, the PLA-based molded bead foam article includes identifying information printed directly on the at least one skin-formed portion of the at least one surface. As described previously, the skin-forming process produces a smooth surface, and it has been unexpectedly discovered that the skin-formed portion is suitable for direct printing of identifying information, eliminating the need for labels.

In some embodiments, the identifying information is printed with ink comprising ethanol, methyl ethyl ketone (MEK), water, or a combination thereof, thereby preserving the recyclability of the PLA-based molded article.

In some embodiments, the molded bead foam article has an anisotropic compressive modulus, an anisotropic flexural modulus, or both. It has been unexpectedly discovered that by skin-forming at least a portion of at least one surface to form a skin-formed surface, the mechanical properties of the bead foam article can change anisotropically. The use of such bead foam articles can provide differentiated protection when exposed to horizontal and vertical vibration simultaneously. For example, a tall and heavy object can use anisotropic foam protective edges which resist compression and potentially damaging oscillations in vertical direction while providing simple contact protection in horizontal direction. In contrast, a high density EPS-based foam article designed for compression in, for example, the vertical direction would have inferior protection in horizontal direction. The anisotropic nature of skin-formed foam advantageously enables foam that is easier to manually break or fracture in one direction than another. Protective packaging utilizing skin-formed foam with anisotropic mechanical properties can therefore break into smaller pieces when removing from the box or enable the consumer to break the protective packaging into smaller pieces that more easily fit in a waste receptacle. Furthermore, configuring the foam to have designed breakage minimizes the production of stray beads upon breakage.

The molded bead foam article having at least one skin-formed portion of at least one surface may be intended for use in shipping heavy appliances; the skin-formed portion may be positioned beneath the foot or wheel of a heavy appliance because the molded bead foam article has an increased compressive modulus in the direction perpendicular to the skin-formed portion.

In some embodiments, the molded bead foam article is in the form of a protective-guard, such as an edge-guard or corner-guard, having a plurality of sides. In some embodiments, fewer than all sides of the protective-guard have a skin-formed portion. It has been unexpectedly discovered that by forming a box having select sides with at least one skin-formed portion, the mechanical protection of the protective guard may be tailored for the application or goods stored/shipped inside. Previous attempts to produce packaging with customized mechanical properties include the use of additional foam pieces, sometimes formed from a different material or having a different density which would require a secondary molding process and/or apparatus. Skin-forming at least a portion of the surface of a molded bead foam article to produce a skin-formed portion may be performed within the same mold as the molded bead foam article itself, immediately after molding on a small piece of equipment proximal to the mold, or after receipt of the molded bead foam article by a user but before installation as protective packaging, thereby enabling the production of custom packaging at minimal material and manufacturing cost.

In some embodiments, the molded bead foam article is in the form of a fold-flat shipper configured to fold into a container for shipping commodities. As used herein, a “fold-flat shipper” refers to a shipper that may be unfolded into a flat configuration. For example, a shipper in the form of a 6-sided box may be unfolded so that each of the 6 sides are flat, and each of the 6 sides is connected to at least one other side. It has been unexpectedly discovered that skin-forming a portion of at least one surface of the molded bead foam article permits formation of a surface suitable for printing identifying information such as shipping details and product identification. In some embodiments, the boundary between two sides of a fold-flat shipper are joined to produce a self-standing box. The properties of a box made with fold flat “C”-shaped panels or individual panels is comparable to a molded box with similar dimensions. Skin-forming more than one side increases tensile and compression properties. The fold-flat shipper occupies around 80% less volume during shipment and storage.

Skin-formed molded articles as described herein may be used in applications such as head rests in automobiles. For example, a shaped foam article may be selectively skin-formed to achieve a desired balance of compression, tensile, and shear strength, providing the necessary rigidity for withstanding normal stresses in a vehicle while also providing a selectively “softer” or more cushioned feel for the passenger.

Another potential application for skin-formed molded articles relates to spare tire covers, which sometimes include recesses for tire-removal tools or other equipment. These covers are often made from expandable polypropylene (EPP). The advantageous ability for skin-forming around holders or grip points enables the use of PLA for spare tire covers, increasing the compressive strength of the tire cover without compromising the ability to incorporate grips or recesses for tools. Skin forming at the edges of the spare tire cover provide addition abrasion resistance and strength.

Methods for Producing Molded Foam Articles

Methods for producing molded foam articles are also disclosed herein. In one aspect, the methods include producing a molded bead foam article as described above. In another aspect, the method includes molding a plurality of foam beads including polylactic acid to produce a molded foam article, and skin-forming at least a portion of at least one surface of the molded bead foam article.

In some embodiments, the method includes skin-forming at least a portion of at least one surface of the molded bead foam article while the molded bead foam article is in the mold. In other embodiments, the at least one portion is skin-formed after the molded bead foam article has been removed from the mold.

In some embodiments, the method includes selectively reinforcing one or more sides and/or one or more corners with a skin-formed portion. As described previously, skin-forming one or more sides and/or one or more corners advantageously increases compressive resistance on the sides and/or corners, increasing drop resistance without changes to density.

In some embodiments, the method include printing identifying information on the skin-formed portion.

In some embodiments, the method is performed in-line. In other words, each step of forming the molded foam article is performed subsequently in approximately the same location. In some embodiments, the method is performed by automated apparatus. In other words, apparatus such as robotic instruments may perform each step necessary for forming the molded foam article, such as deliver the foam particles to the mold, mold the molded foam article, remove the molded foam article from the mold, transport the molded foam article to a skin-forming apparatus, fold the molded foam article into a shipper, and the like. It has been unexpectedly discovered that skin-forming at least a portion of one or more surfaces of the molded foam article to form a skin-formed portion increases thermal and mechanical properties over that of shippers containing for example, cotton bats, paper or starch liners, or extruded starch solutions, which are common degradable solutions used instead of conventional EPS.

The methods described herein advantageously enable the ability to, for example, skin-form the circumference of a circular-shaped panel without changing the properties of the top or bottom surfaces. This advantageously enables the circular panel to have higher compressive strength. Such modification can be made to a panel having any shape to selectively increase the compressive strength of the panel.

The methods described herein further advantageously enable the ability to alternate between skin-formed portions and non-skin-formed portions on the same article for superior protection. In other words, skin-forming is possible on discrete portions or locations and is not limited to the entire surface. By forming molded foam articles having discrete skin-formed portions, superior cushioning may be formed by having skin-formed portions alternating with portions without skin-forming.

### EXAMPLES

The disclosure may be further understood with reference to the following non-limiting examples.

### Example 1: Leak-Proof PLA-Based Panel

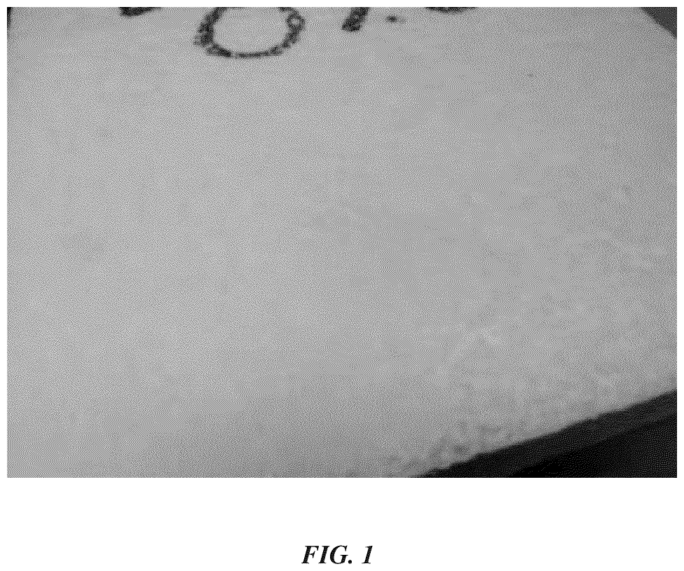

A PLA-based foam panel was produced as described herein. In order to skin the surface of the panel, the panel was pressed with a t-shirt press platen for 15 seconds at 310° F. After removal from the platen, the skin-formed surface was observed to have a smooth appearance due to the reduction in texturing, as depicted in FIG. 1. The panel was subsequently subjected to the standard water-elution test used for EPS-based molded articles. The panel was machined into a disc having a diameter of 3 inches, a thickness of 1.5 inches, and a hollow column was positioned on top of the disc and filled with 1000 mL of water. After 15 minutes, no water was observed to have penetrated or eluted through the disc. In contrast, a PLA-based panel without a skin-formed surface exhibits water elution or water droplets after 2-3 minutes.

### Example 2: Extended Leak-Proof Test of PLA-Based Panel

A PLA-based foam panel was produced as described herein was skin-formed as described in Example 1. The panel had dimensions of 8″×8″×1.5″. The panel was manipulated into a “bowl”-like shape. 250 mL of water was placed in the “bowl” and the panel was allowed to stand overnight. No water elution was observed. The panel weight increased by about 0.1 g (an increase of less than 1%), representing some water absorption into the surface of the panel.

### Example 3: Flexural Properties of PLA-Based Molded Foam Articles with Skin-Formed Surfaces

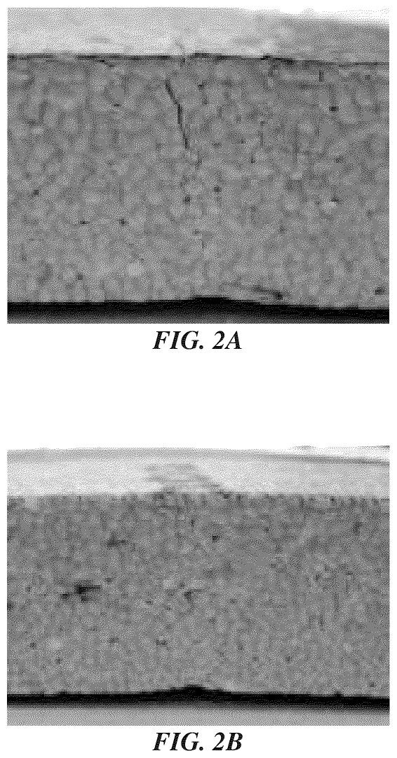

PLA-based molded foam articles were produced as described herein. The articles had a thickness of 1.5″ and cut into strips 2″ wide in accordance with ASTM C203. Three strips were not skin-formed. Six strips were skin-formed for 20 seconds on one side using a platen having a temperature of 310° F. Three skin-formed strips were tested according to ASTM C203 such that the cross bar used in the standard test contacts the skin-formed surface, and three skin-formed strips were tested such that the cross bar contacts the opposing surface. The three non-skin-formed strips and the three skin-formed strips tested with the cross bar (FIG. 2A) contacting the skin-formed surface had a flexural strength of 45.6 psi and an elasticity of 416. The three skin-formed strips tested with the cross bar opposite to the skin-formed surface (FIG. 2B) had a flexural strength of 50 psi and an elasticity of 637.

### Example 4: Compressive Strength of PLA-Based Molded Foam Articles with Skin-Formed Surfaces

PLA-based molded foam panels were produced as described herein. The panels had a density of 1.5 pcf. The top surface of a panel was skin-formed for 20 seconds at 310° F. The compressive strength of the panel was measured by applying compressive force to the skin-formed surface. Before skin-forming, the panel had a compressive strength of 18 psi. After skin-forming, the panel had a compressive strength of 20 psi. The compressive strength of the panel was relatively unchanged because the skin-forming occurred in a direction perpendicular to the measurement.

### Example 5: Compressive Strength Changes from Skin-Forming Adjacent Surfaces

PLA-based molded foam cubes were produced as described herein. The cubes had a density of 1.5 pcf. Two opposing sides of a first cube were skin-formed and the compressive force of the resulting skin-formed cube was measured by applying force to a non-skin-formed side in a direction parallel to the skin-formed sides. In other words, force was applied to the “top” of the cube having “left” and “right” sides skin-formed. Before skin-forming, the first cube had a compressive strength of 18 psi. After skin-forming two opposing sides, the cube had a compressive strength of 28.4 psi. A second cube was skin-formed on four adjacent sides and force applied in a direction parallel to the skin-formed sides. In other words, force was applied to the “top” of the second cube having “left,” “right,” “front,” and “back” sides skin-formed. Before skin-forming, the second cube had a compressive strength of 18 psi. After skin-forming four sides, the second cube had a compressive strength of 32.4 psi. Absent skin-formed surfaces, a similar increase in compressive strength would require an increase in foam density of around 60%-80%.

Furthermore, the second cube having four skin-formed sides exhibited a compressive strength of 20 psi when measured on any of the four skin-formed surfaces (so that two skin-formed surfaces and two non-skin-formed surfaces were parallel to the direction of force), and a compressive strength of 32.4 psi when measured on an non-skin-formed surface (so that all four skin-formed surfaces were parallel to the direction of force). These anisotropic properties were obtained without any change in material, change in density, or change in foam particle size.

### Example 6: Printing Identifying Information Directly on Skin-Formed Surface

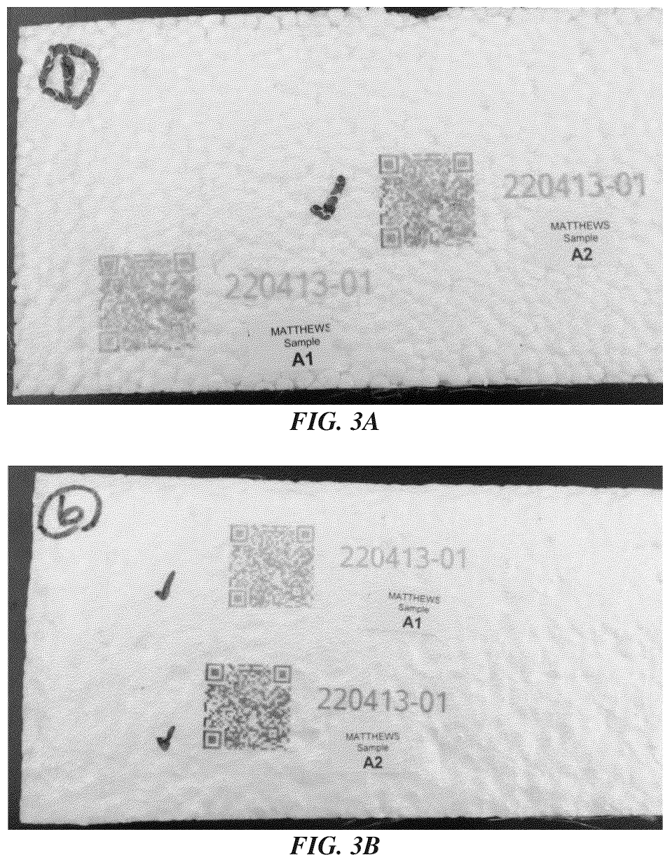

PLA-based molded foam articles were produced as described herein and barcodes were printed on the surface of the articles. A VIAjet™ L12 printed was equipped with LS6101 Black as the “A1” ink, which utilizes ethanol as a solvent, and LS7011 Black as the “A2” ink, which uses MEK as a solvent. The printing was performed on a moving conveyor at a line speed of 50 feet per minute. The ink jet head was chosen for 300 dpi resolution printing of a QR code with a size of 96×86 pixels. Printing was performed on both skin-formed and non-skin-formed surfaces and the ink allowed to dry for 2 seconds. In this test, the ability to read/scan the QR code was determinative of the printing quality. FIG. 3A depicts the printing quality on a non-skin-formed surface for both A1 and A2 ink, and FIG. 3B depicts the printing quality on a skin-formed surface for both A1 and A2 ink. Only A2 ink produced a scannable QR code on a non-skin-formed surface, but both inks were viable on a skin-formed surface.

### Example 7: Skin-Forming Process on EPS-Based Molded Articles

EPS-based molded articles were formed having a density of 1.2 pcf and a thickness of 1.5 inches. These articles had an initial flexural strength of 0.213 MPa. When the freshly molded EPS is exposed to a heated platen having a temperature of 250° F., the foam beads over-expanded and formed a bumpy, uneven surface. This excess expansion resulted in a small reduction in flexural strength with deteriorating cosmetic appearance. When freshly molded EPS having a thickness of 1.5 inches was exposed to a heated platen having a temperature of 300° F., the foam beads contracted and melted to form a skin which is highly crystalline. This resulted in a 30% decline in flexural strength and a 20% decline in elasticity when tested to ASTM C203. When freshly molded EPS was exposed to a heated platen, additional pentane blowing agent was released from the EPS as demonstrated by a strong odor emitting from the panel. Thus, extended periods of processing EPS with a heated platen would require additional ventilation to prevent the build-up of VOCs such as pentane in the air. EPS which has been aged at least 72 hours was less reactive than freshly molded EPS, but it also formed a crystalline surface which reduced the flexural strength and elasticity of articles. The skin-forming process resulted in a flexural strength reduction to 0.146 MPa.

### Example 8: Skin-Forming Process on EPP-Based Molded Articles

EPP-based molded articles were formed using a conventional process and allowed to age. One EPP-based article having a thickness of 1.5 inches was exposed to a heated platen having a temperature of 250° F. No change to the exterior surface of the EPP articles was observed for the 250° F. test. For a heated platen having a temperature of 300° F.-310° F., the surface of the EPP-based article began to change with the boundaries between individual beads softening and smoothing. For a heated platen having a temperature of 310° F.-320° F., the article melted and lost ⅛ inch in thickness with voids forming between beads as they melted. It was not possible to form a skin on the EPP-based molded article due to its sensitivity to such high heats and its tendency to melt.

### Example 9: Skin-Forming Process on EPE-Based and E(PS-Co-PE)-Based Molded Articles

Expandable polyethylene (EPE)-based molded articles were purchased from Worldwide Foam, Indiana, USA and expandable polystyrene/polyethylene co-polymer (E(PS-co-PE))-based molded articles were purchased from Engineered Foam Products Ltd., Northampton, England, United Kingdom. The E(PS-co-PE) was Arcel® brand product. The articles were subjected to a heated platen at various temperatures between 200 to 320° F. No change in surface appearance was observed at the lower temperatures and residence times. At higher temperatures, the surface of both the EPE-based and E(PS-co-PE)-based articles displayed a rough surface, evidencing a small reduction in flexural strength.

While the disclosure has been described with reference to a number of embodiments, it will be understood by those skilled in the art that the disclosure is not limited to such embodiments. Rather, the disclosure can be modified to incorporate any number of variations, alterations, substitutions, or equivalent arrangements not described herein, but which are commensurate with the spirt and scope of the disclosure. Conditional language used herein, such as “can,” “could,” “might,” or “may,” unless specifically stated otherwise, or otherwise understood within the context as used, generally is intended to convey that certain embodiments include, while other embodiments do not include, certain features, elements or functional capabilities. Additionally, while various embodiments of the disclosure have been described, it is to be understood that aspects of the disclosure may include only some of the described embodiments. Accordingly, the disclosure it not to be seen as limited by the foregoing described, but is only limited by the scope of the appended claims.

1. A molded bead foam article comprising polylactic acid, wherein the molded bead foam article comprises at least one surface, wherein at least a portion of the at least one surface has been skin-formed.

2. The molded bead foam article of claim 1, wherein the skin-formed portion of the at least one surface has a greater compressive resistance than a conventional EPS-based foam article having the same density.

3. The molded bead foam article of claim 1, wherein the skin-formed portion of the at least one surface has a lower density than a conventional EPS-based foam article having the same compressive resistance.

4. The molded bead foam article of claim 1, wherein the skin-formed portion of the at least one surface has a compressive resistance that is 30%-50% greater than a surface of a PLA-based molded bead foam article that has not been skin-formed.

5. The molded bead foam article of claim 1, wherein the skin-formed portion of the at least one surface comprises a skin-formed corner or skin-formed edge of the molded bead foam article, and wherein the skin-formed corner or skin-formed edge is effective to increase a drop resistance of the molded bead foam article without changing the density.

6. The molded bead foam article of claim 1, wherein the skin-formed portion of the at least one surface has a density of between about 1.0 pcf and about 6.0 pcf.

7. The molded bead foam article of claim 1, wherein the skin-formed portion of the at least one surface is leak-proof.

8. The molded bead foam article of claim 1, wherein the skin-formed portion of the at least one surface has an R-value that is unchanged in at least 1 year when exposed to water.

9. The molded bead foam article of claim 1, further comprising identifying information printed directly on the skin-formed portion of the at least one surface.

10. The molded bead foam article of claim 9, wherein the identifying information is printed with ink comprising ethanol, methyl ethyl ketone, water, or a combination thereof.

11. The molded bead foam article of claim 1, wherein the molded bead foam article has an anisotropic compressive modulus and/or an anisotropic flexural modulus.

12. The molded bead foam article of claim 1, further comprising a label with product information printed directly on the skin-formed surface.

13. The molded bead foam article of claim 1, wherein the molded bead foam article is in the form of a box having a plurality of sides.

14. The molded bead foam article of claim 13, wherein fewer than all sides of the box have a skin-formed portion of a surface.

15. The molded bead foam article of claim 1, wherein the molded bead foam article is in the form of an automobile headrest.

16. The molded bead foam article of claim 1, wherein the molded bead foam article is in the form of a spare wheel cover.

18. (canceled)

17. The molded bead foam article of claim 1, wherein the molded bead foam article comprises blends or copolymers of polylactic acid.

18. A method for producing a molded bead foam article comprising:
molding a plurality of foam beads comprising polylactic acid in a mold to produce the molded bead foam article, and
skin-forming at least a portion of at least one surface of the molded bead foam article.

19. The method of claim 18, wherein the skin-formed portion of the at least one surface is skin-formed while the molded bead foam article is in the mold.

20. The method of claim 18, wherein the skin-formed portion of the at least one surface is skin-formed after the molded bead foam article has been removed from the mold.

21. The method of claim 18, further comprising printing identifying information on the skin-formed portion of the at least one surface.

22. The method of claim 18, wherein the method is performed in-line.

23. The method of claim 18, wherein the method is performed proximal to a packaging facility.

24. The method of claim 18, wherein the method is performed by automated apparatus.

25. The molded bead foam article of claim 1, wherein the at least one surface with the skin-formed portion is curved.
